(19) United States
(12) Patent Application Publication
(10) Pub. No.: US 2011/0090941 A1
(43) Pub. Date: Apr. 21, 2011

(54) Method And Apparatus For Retransmitting Information

(75) Inventor: Li Erran Li, Edison, NJ (US)

(73) Assignee: Alcatel-Lucent USA Inc., Murray Hill, NJ (US)

(21) Appl. No.: 12/827,202

(22) Filed: Jun. 30, 2010

Related U.S. Application Data
(60) Provisional application No. 61/253,724, filed on Oct. 21, 2009.

(51) Int. Cl. H04B 1/38; H04L 27/00

(52) U.S. Cl. 375/219; 375/295

(57) ABSTRACT

To address the need for new techniques that are able to address overlapping channel collisions various embodiments are described. They are used to introduce the concept of retransmission-permutation, in which a bit-to-subcarrier assignment is permuted (1301) during packet retransmission (1302), thus departing from the well-known, simply-repeat paradigm. Various embodiments are straightforward to implement and able to exploit collision-free subcarriers to decode packets despite successive collisions in overlapping channels.

### REFERENCE(S) TO RELATED APPLICATION(S)

The present application claims priority from a provisional application, Ser. No. 61/253,724, entitled “METHOD AND APPARATUS FOR RETRANSMITTING INFORMATION,” filed Oct. 21, 2009, which is commonly owned and incorporated herein by reference in its entirety.

### FIELD OF THE INVENTION

The present invention relates generally to communications and, in particular, to retransmitting information in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

As OFDM becomes the foundation of modern high-speed wireless networks due to its advantages such as lower symbol rate, effective usage of a large frequency band, and resistance to frequency-selective fading, collisions in overlapping OFDM channels become an increasingly important problem in the deployment of high-speed wireless networks. Specifically, in an OFDM network, each channel is allocated a set of subcarriers, and two channels overlap when the intersection of their sets of subcarriers is not empty. Consider 802.11 g, which is becoming almost ubiquitously deployed in many residential neighborhoods. With only 3 non-overlapping channels with disjoint sets of subcarriers but a large number of access points in densely populated neighborhood, it is inevitable that many 802.11 access points in range of each other use overlapping channels, as observed by previous measurement studies (e.g., [1]). Although one may try to alleviate the shortage of orthogonal channels by using variable bandwidth channels, as advocated in [5, 10], bursty or time varying workload can pose a problem for channel width adaptation. As the authors of [15] have shown, partially overlapping channels may improve network throughput even in managed 802.11 networks, when the number of orthogonal channels is limited. Channel overlapping is also allowed in WiFi networks built on digital white spaces [2].

However, collisions in overlapping OFDM channels during congestion or in the presence of hidden terminals are distinct from collisions in a single-channel setting, and they are becoming an increasingly important problem in the deployment of high-speed wireless networks. For example, if one base station or access point uses channel 1, a nearby one uses channel 2 (channel 1 and 2 overlap), then overlapping channel collisions can become a serious problem. Currently deployed systems retransmit when collisions occur. The hope is that the retransmission will go through interference free. However, persistent collisions can occur frequently due to MAC effect or hidden terminal problems. The best existing solution appears to be Zigzag decoding (see, e.g., [7]); however, it does not deal with overlapping channel collisions very well. Thus, new solutions and techniques that are able to address overlapping channel collisions would meet a need and advance wireless communications generally.

### BRIEF DESCRIPTION OF THE DRAWINGS

FIG. 1 is a block diagram depiction of a bit-to-subcarrier mapping schedule in accordance with various embodiments of the present invention.

FIG. 2 is a diagram depicting a packet from Alice to AP1 colliding with a packet from Bob to another AP.

FIG. 3 is a block diagram depicting a subcarrier view of collisions on a non-adjacent channel in accordance with various embodiments of the present invention.

FIG. 4 is a block diagram depicting a subcarrier view of collisions on an adjacent channel in accordance with various embodiments of the present invention.

FIG. 5 is a block diagram depicting a decoding graph in accordance with various embodiments of the present invention.

FIG. 6 is a graph depicting a scatter plot of bit error rate (BER) for experiments on non-adjacent channel collision (channel 3 and 5).

FIG. 7 is a graph depicting a scatter plot of throughput for experiments on non-adjacent channel collision (channel 3 and 5).

FIG. 8 is a block diagram depicting a subcarrier view of collision with an adjacent channel in accordance with various embodiments of the present invention.

FIG. 9 is a block diagram depicting a decoding graph in accordance with various embodiments of the present invention.

FIG. 10 is a block diagram depicting the decoding of overlapped collisions for a first case, in accordance with various embodiments of the present invention.

FIG. 11 is a block diagram depicting the decoding of overlapped collisions for a second case, in accordance with various embodiments of the present invention.

FIG. 12 is a logic flow diagram of retransmitting information in accordance with various embodiments of the present invention.

FIG. 13 is a logic flow diagram of retransmitting information in accordance with various embodiments of the present invention.

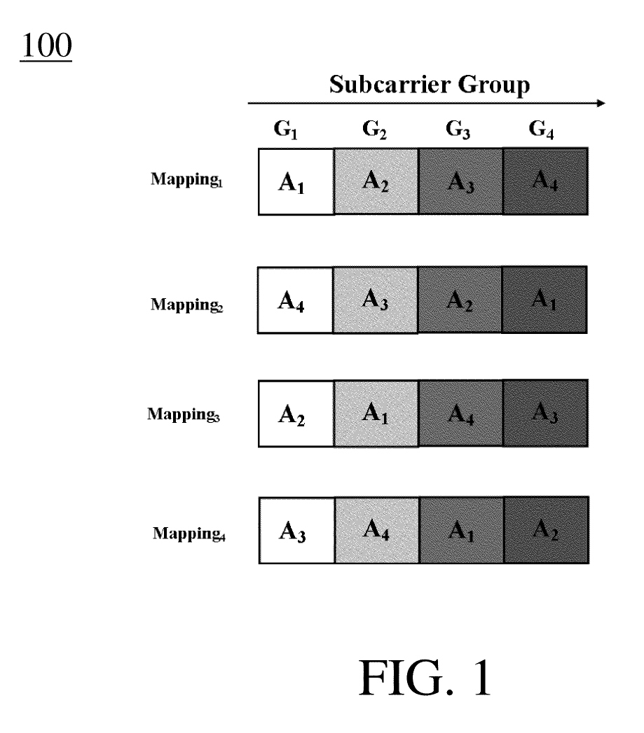

Specific embodiments of the present invention are disclosed below with reference to FIGS. 1-13. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

Various methods and devices are provided to address the need for new techniques to handle overlapping channel collisions. In one method, a first mapping is generated for information to be transmitted via a channel. The channel includes a plurality of subcarrier groups, a first portion of the information is mapped to a first subcarrier group of this plurality of subcarrier groups and a second portion of the information is mapped to a second subcarrier group of the plurality of subcarrier groups. The information is transmitted via the channel using the first mapping. A second mapping is generated for the information. A first portion of the information is mapped to a subcarrier group of the plurality of subcarrier groups that is different than the first subcarrier group, while a second portion of the information is mapped to a subcarrier group of the plurality of subcarrier groups that is different than the second subcarrier group. The information is retransmitted via the channel using the second mapping. An article of manufacture is also provided, the article comprising a processor-readable storage medium storing one or more software programs which when executed by one or more processors performs the steps of this method.

In another method, information is remapped according to an information-to-subcarrier remapping schedule. Various portions of the information are mapped to different subcarrier groups than the various portions of the information were mapped to in a previous transmission of the information. The information is retransmitted in accordance with the remapping that is performed. An article of manufacture is also provided, the article comprising a processor-readable storage medium storing one or more software programs which when executed by one or more processors performs the steps of this method.

Various transceiver node apparatuses are also provided. A first transceiver node being configured to communicate with other devices of a system and being operative to generate a first mapping for information to be transmitted via a channel, where the channel comprises a plurality of subcarrier groups. A first portion of the information is mapped to a first subcarrier group of the plurality of subcarrier groups and a second portion of the information is mapped to a second subcarrier group of the plurality of subcarrier groups. The first transceiver node is also operative to transmit the information via the channel using the first mapping and to generate a second mapping for the information, where a first portion of the information is mapped to a subcarrier group of the plurality of subcarrier groups that is different than the first subcarrier group and where a second portion of the information is mapped to a subcarrier group of the plurality of subcarrier groups that is different than the second subcarrier group. The first transceiver node is also operative to retransmit the information via the channel using the second mapping.

A second transceiver node being configured to communicate with other devices of a system and being operative to remap information according to an information-to-subcarrier remapping schedule, where various portions of the information are mapped to different subcarrier groups than the various portions of the information were mapped to in a previous transmission of the information. The second transceiver node is also operative to retransmit the information in accordance with the remapping.

### DETAILED DESCRIPTION OF EMBODIMENTS

To provide a greater degree of detail in making and using various aspects of the present invention, a description of our approach to retransmitting information and a description of certain, quite specific, embodiments follows for the sake of example. FIGS. 1-11 are referenced in an attempt to illustrate some examples of specific embodiments of the present invention and/or how some specific embodiments may operate.

Remap is the paradigm proposed herein for handling collisions in OFDM networks with overlapping channels. Different from the existing, passively-repeat paradigm, Remap introduces the concept of retransmission-permutation that permutes the bit-to-subcarrier mapping after each retransmission. Retransmission-permutation is a powerful diversity technique [18] that can recover frequency selective losses from subsequent retransmission when there is no collision. When there are collisions, it in essence provides channel-width adaption and allows bootstrapping the decoding of collided packets that may otherwise not be possible.

Specifically, the foundation of Remap is based on the observation that when two packets transmitted in overlapping channels collide, only the subcarriers in the intersection of the two channels collide and the bits in other subcarriers are clean and can be collected. However, the non-colliding subcarriers do not contain complete packet information. The idea of Remap is to introduce structured permutation on the mapping from bits to subcarriers after each collision to create structured diversity. This diversity allows either independent decoding or bootstrapping other decoding techniques such as Zigzag decoding [7]. Integrating Remap with an existing system requires minimal change to the OFDM physical layer.

In particular, we have designed 802.11 g/Remap, which applies Remap to 802.11 g to demonstrate its effectiveness. We show that using the diversity created by remapped packets, an 802.11 g receiver a can decode any packet Pₐ after 4 collisions with other transmissions in adjacent channels; the number of collisions reduces to 2 if the other transmissions are not in adjacent channels. These numbers do not make any assumptions on the packets collided with Pₐ. If the packets collided with Pₐ are the same (i.e., both collisions are between Pₐ and another packet P_{b}), Remap can bootstrap decoding both packets with the bits on the collision-free subcarriers. Decoding both packets at a single AP is important so that the combiner (used in systems such as [16]) behind the APs can make use of the reception diversity. In contrast, without Remap, Zigzag cannot decode both packets. Furthermore, 802.11 g/Remap is backwards compatible with 802.11 MAC. Thus, 802.11 g/Remap can be deployed with simple software and firmware updates to the vast existing 802.11 networks.

We have implemented 802.11 g/Remap in a software radio test-bed. Our experimental results show that Remap works and achieves a BER on decoding collision-free subcarriers that is very close to collision-free transmissions when the interference signal strength is smaller than the desired signal by at least 5 dB.

We use 802.11 g to illustrate our basic idea. In standard 802.11 g, data bits are assigned to subcarriers. We denote the first 16 subcarrier frequencies of 802.11 g as G₁, the next 16 as G₂, etc. Each 802.11 g channel consists of 64 consecutive subcarrier frequencies (only 48 subcarriers carry data bits). Thus, the first channel C₁ of 802.11 g consists of G₁, G₂, G₃ and G₄; channel C₂ consists of G₂, G₃, G₄ and G₅; channel C₃ consists of G₃, G₄, G₅ and G₆; channel C₄ consists of G₄, G₅, G₆ and G₇, etc. Note that C₁ overlaps with C₁, C₂, C₃ and C₄. We say that C₂ is an adjacent channel of C₁; C₃ and C₄ are overlapping non-adjacent channels of C₁. (Note that non-overlapping channels do not equal orthogonal channels; due to imperfect filtering, guard bands are needed to achieve orthogonality. Our decoding technique is subject to adjacent channel interference.)

Assume that a sender uses channel C₁ to send a packet P consisting of data bits A₁, A₂, A₃, and A₄. Let the bit-to-subcarrier assignment be that A₁->G₁, A₂->G₂, A₃-<G₃, and A₄->G₄. In other words, the bits A₁ are assigned to be carried by subcarrier group G₁, A₂ by G₂, A₃ by G₃, and A₄ by G₄. If the transmission for packet P is not successful, 802.11 g retransmits the packet P where the bit-to-subcarrier assignment is the same.

In contrast, in the Remap approach during a retransmission, permutation scheduling of bit-to-subcarrier mapping is performed. Diagram 100 of FIG. 1 depicts a schedule of bit-to-subcarrier mapping for 802.11 g. As shown in diagram 100, for the original transmission, bits A₁, . . . , A₄ are mapped to subcarrier groups G₁, . . . , G₄ respectively. For the first retransmission, bits A₄, A₃, A₂, A₁ are mapped to subcarrier group G₁, . . . , G₄ respectively. The third and fourth rows are for the second and third retransmissions. We cycle through these four mappings for more retransmissions. We only need 2 bits to encode the four mapping schemes. We can use four of the reserved bits in the SERVICE field of the PLCP header.

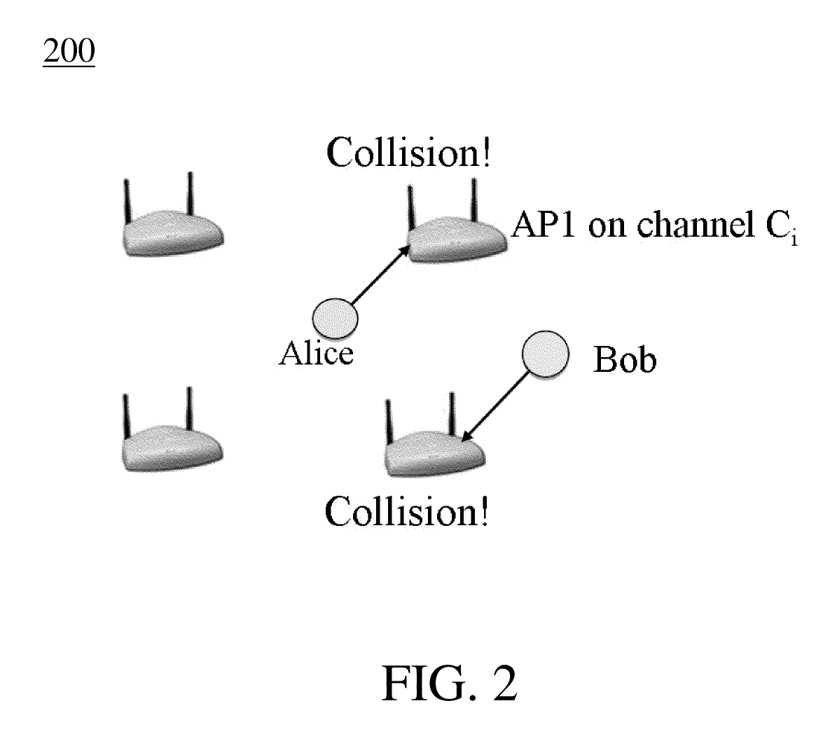

Having described by example the basic idea, we now demonstrate the benefits of Remap using another example. Consider two residential users, Alice and Bob, who use 802.11 g to connect to access points APₐ and AP_{b} respectively. Let the channel between Alice and APₐ be Cₐ, and that between Bob and AP_{b} be C_{b}. Assume that the two channels are overlapping channels. Diagram 200 of FIG. 2 shows the setting.

Due to hidden terminals or randomness, Alice may transmit a packet Pₐ to APₐ concurrently with Bob transmitting a packet P_{b} to AP_{b}, causing collisions at APₐ and AP_{b}. Without receiving an acknowledgment, Alice retransmits Pₐ, which may again collide with a transmission of Bob for packet P_{b}. Note that P_{b} may be different from P_{b} due to rescheduling. Without Remap, packet Pₐ cannot be decoded by the access point APₐ so long there are collisions.

Remap, however, allows decoding of collided packets. To illustrate our idea, we consider how APₐ decodes Pₐ. We will show that Remap allows APₐ to decode Pₐ after at most 3 retransmissions. We illustrate three cases.

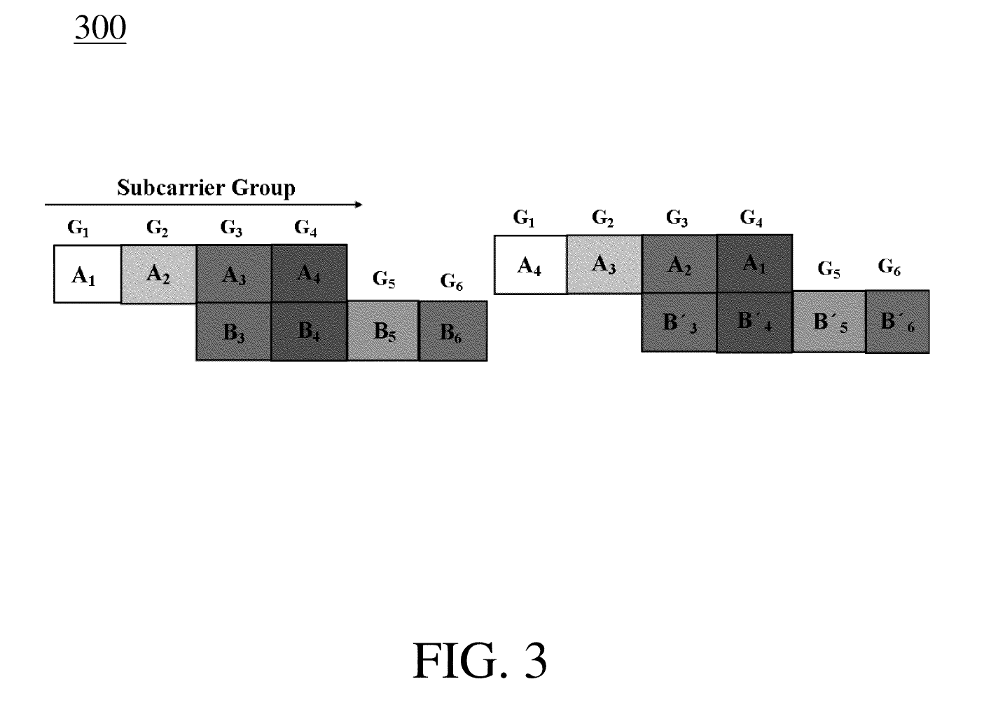

Collisions in Non-adjacent Channels: Diagram 300 of FIG. 3 depicts the first case, when Alice and Bob use overlapping but nonadjacent channels: Alice uses C₁ and Bob uses C₃. Diagram 300 shows the collided packets in the frequency domain. We can check that APₐ can decode packet Pₐ after Alice retransmits the packet only once.

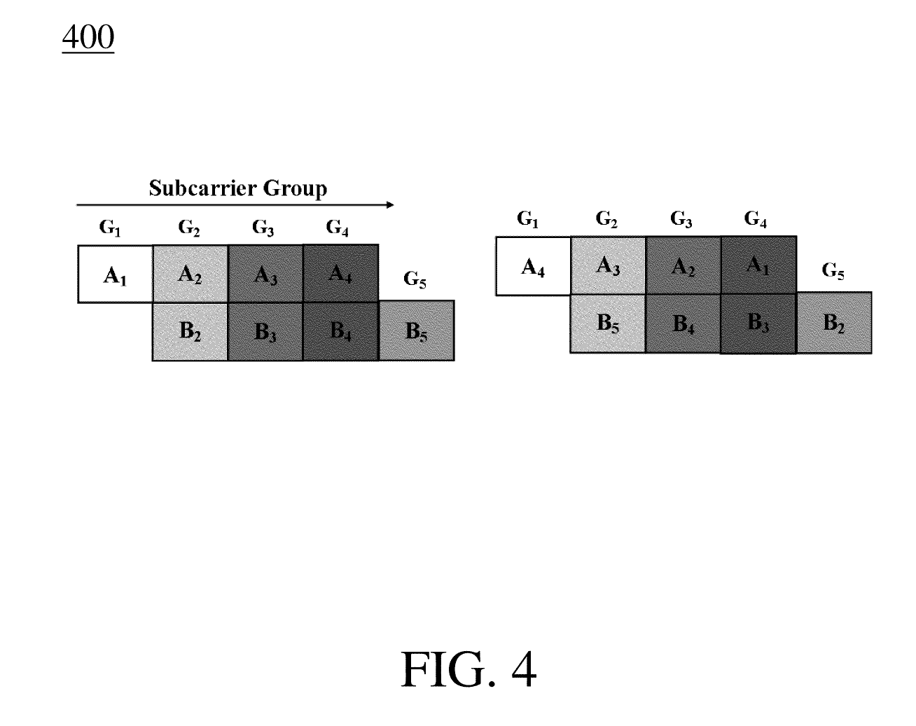

Collisions in Adjacent Channels: The worst-case of 3 retransmissions happens when Alice and Bob use adjacent channels: Alice uses C₁ and Bob uses C₃. Diagram 400 of FIG. 4 shows the first transmission and one retransmission. After the two transmissions, bit blocks A₁ and A₄ will be recovered. Two additional collisions will yield A₂ and A₃, allowing full recovery.

Matching Collisions: The worst case of 3 retransmissions does not make any assumption on the packets that collided with Pₐ. When the first two packets that collided with Pₐ are the same, Remap can achieve higher efficiency. We refer to this case as matching collisions.

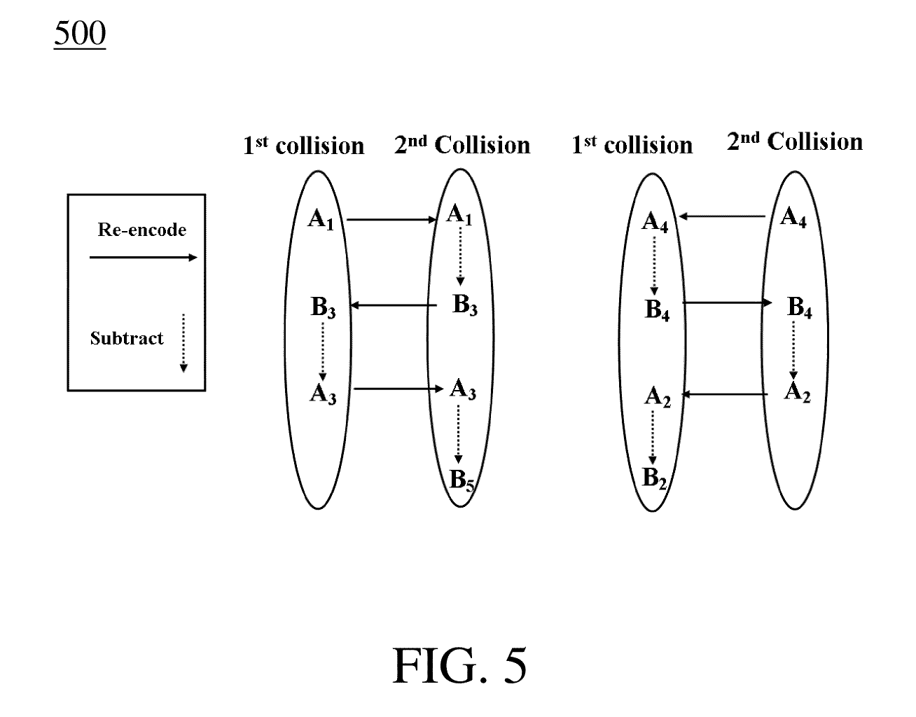

Specifically, for the case of matching collisions, Remap uses bits that are mapped to collision-free subcarriers to bootstrap more advanced decoding motivated by ZigZag decoding. Again, see diagram 400. For the example, we have bit sequences A₁ and A₄ which are on collision-free subcarriers. A₁ is the bit sequence of all the symbols of Pₐ that are mapped to subcarrier group 1. We first decode them. Once we decode A₁, we then re-encode them onto subcarrier group 4. We subtract the re-encoded signal from the second collision so that we can decode B₃. When we get B₃, we further re-encode them onto subcarrier group 3 and subtract from the first collision. After the subtraction, we can decode A₃ from the first collision. Similarly, A₃ causes B₅ to get decoded. We then decode from A₄. A₄ causes B₄ to be decoded from the first collision. B₄ causes A₂ to get decoded from the second collision and followed by B₂. Thus, we can decode all bits in all subcarriers, even the bits of the second packet transmitted in subcarriers outside of channel k in the first transmission! Diagram 500 of FIG. 5 depicts the decoding graph. Note that, for simplicity, we have presented a simplified view of 802.11 g subcarrier structure. For 802.11 g, there are unused subcarriers, so we need to define subcarrier groups in terms of unused subcarrier groups. In this definition, the subcarrier groups are not aligned. However, this does not present any decoding problem.

### Remap Details

In this section, we give more details on some key issues related to Remap. We use 802.11 g to be concrete. Our presentation setting is that an 802.11g·AP tries to decode packets (Pₐ, P′ₐ) from a sender A to the AP. We refer to the transmissions from A to the AP as the primary channel. The transmissions from other transmitters, say packets P_{b} and P_{b} from a sender B to another targeted receiver, are called secondary channels. (We focus on the case of one secondary channel but the scheme can be extended to multiple channels.) The secondary channels cause interference to the primary channel.

Detecting Collisions

To detect a collision, the AP exploits the known preamble with which every packet starts. 802.11 g preamble consists of 10 identical short symbols, each of 16 samples, and 2 identical long symbols, each of 64 samples. 802.11 g receiver does auto-correlation of the first 160 received samples. It then shifts one sample at one time, and performs auto-correlation on another 160 samples starting at the shifted positions. Because the preamble is independent of A and B's data, the correlation of the preamble samples with A and B's data should be close to zero.

If the correlation peaks in the middle of the packet, then it is very likely that we have a collision. We now need to determine which channel the collided packet is transmitted on. We use standard energy-detection technique. We illustrate using 802.11 g. Each 802.11 g channel consists of 64 subcarriers (a 20 MHz channel). As discussed before, we partition them into 4 groups. We try to find out which group's energy has significant change before and after the correlation peak. Based on 802.11 g channel structure, once we determine which subcarrier groups experience collision, we can infer which channel the second packet is transmitted on.

Detecting Matching Collisions

Once an AP determines the received signal is the result of collision, it will search for a matching collision (a collision of the same two packets). Each AP stores recent unmatched collisions. Because senders in 802.11 keep retransmitting a failed transmission as soon as the medium is free, it is sufficient to store a few most recent collisions.

We again use correlation to match the current collision against stored collisions. Assume the AP is trying to match two collisions (Pₐ, P_{b}) and (P′ₐ, P′_{b}). The AP knows which channels each of these four packets are transmitted and the timing offsets. Without loss of generality, let us assume Pₐ an P′ₐ are transmitted on prime channels. Because Remap maps bits to different subcarriers during retransmissions, we cannot simply perform a correlation in the time domain.

We perform a FFT on the received mixed samples y and y using the timing of A's packet. Let N be the number of subcarriers and M be the number of symbols in each packet. After correcting frequency offsets, let Y[l,i], Y′[l,i] be the i-th subcarrier sample of the l-th symbol in the frequency domain for y and y′ respectively. Let Hₐ[i] and H′ₐ[i] be the channel gain associated with the i-th subcarrier of A's channel to her AP. Let Ŷ′[l,i] be the reversed-mapped sample. That is, if subcarrier i is mapped to subcarrier k in P′ₐ, then Ŷ′[l,i]=H′ₐ[i]Y′[l,k]/H′ₐ[k]. The correlation is computed as follows.

$$\begin{matrix}Γ ( {P}_{a} , {P}_{a}^{′} ) = {\sum }_{l = 1}^{M} {\sum }_{i = 1}^{N} {Y}^{*} [ l , i ] {\hat{Y}}^{′} [ l , i ] \\ = {\sum }_{l = 1}^{M} {\sum }_{i = 1}^{N} {\vert {Y}_{a} [ l , i ] \vert}^{2} .\end{matrix} \qquad ( 1 )$$

Note that, we assume the channel of each subcarrier for the retransmitted packet does not change much from the original transmission.

Detecting Modulation

Note that, given one collision, we cannot decode the PLCP header of the overlapping channel packet. Thus, we do not know with what modulation scheme the second packet is encoded. Remap solves this problem nicely. We assume that the channel has not changed much between the two collisions. This is reasonable given that 802.11 is used primarily in indoor environments. Rather than decode and re-encode P_{b}, we subtract the raw samples of P_{b} during the Remap decoding process of adjacent channel collisions. The drawback from decode and re-encode subtraction is added noise. However, PLCP is redundantly encoded; so it is very noise resilient. Once we obtain the PLCP header from the first pass of Remap. We can then apply the normal Remap decoding process. For subsequent bits of the second packet, we decode using the modulation scheme encoded in its PLCP header's Signaling field.

Remap Decoding

The full Remap decoding algorithm is shown in below. Remap decode takes a new collision and the set of saved collisions. channel is the channel that the receiver tunes to.

Remap_decode(colset, y, channel) //colset is the set of collisions
01. scg = colli_subcarrier_groups(y);
02. if (|scg|==4) //co-channel collision

| 03. | Zigzag_decode(colset, y) // account for bits-to-subcarrier |
|---|---|
| | remapping |
| | 04. else |
| 05. | foreach y′ ∈ colset |

| | |
|---|---|
| 06. | if matching_collisions(y, y′, channel); |

| 07. | bit_collector = Remap_decode_matching_pair(y, y′, |
|---|---|
| | channel); |

| | |
|---|---|
| 08. | else matching_packet_in_channel(y, y′, channel); |

| 09. | bit_collector=collect_subcarrier_group_bits(y′, |
|---|---|
| | channel); |

| | |
|---|---|
| 10. | endif |

| | |
|---|---|
| 11. | end foreach |

12. endif
13. bit_collector=collect_subcarrier_group_bits(y, channel);
14. pkt=reconst_pkt(bit_collector);
15. colset = colset ∪ y;
16. return pkt;

We first detect whether collision happens on all 4 subcarrier groups. If so, then the collision is on the same channel. We pass it to the Zigzag decoder. If it is a collision on overlapping channels, we will run through the set of collisions colset. We first see if it is a matching collision pair; if so, we decode matching collisions. If it is not a matching collision pair, we will try to see if and y′ matches y in terms of the packet in channel channel. If that is the case, we will collect bits on collision-free subcarriers.

When we finish the loop, we will further collect collision-free subcarriers from the new collision y. We will then try to reconstruct the pkt in channel channel. If we have enough bits and the decoding passes CRC check, we will return pkt. Otherwise, we will return NULL.

We characterize the effectiveness of Remap using the following theorem:

THEOREM 1. Given k=2, 3 matching collisions. Each sender Sᵢ uses mapping π_{i,j} in collision j=1, . . . , k. If π_{i,j}≠π_{i,j′} as long as j≠j′, then Remap can decode all k collisions.

Issue with Scrambler

All the bits transmitted by 802.11 g are scrambled using a frame synchronous 127 bits sequence generator. Scrambling is used to randomize the input bits to prevent long strings of 1s and 0s. The initial state of the scrambler varies from packet to packet. To unable estimation of sender scrambler state, 802.11 g sets the seven least significant bits of the SERVICE field of the PLCP header to all zeros. Scrambling is done after convolutional encoding.

To enable Remap decoding when the scrambler of the sender changes state from packet to packet. We need to descramble the received samples of a packet (with collisions). To descramble, we need to know the scrambling seed. For the prime channel packet, we can infer the seed from the most recent non-collision packets received from the sender. For the non-prime packet, we may need to try out all possible adjacent seeds (127 of them) for pairs of collisions.

### Evaluations

Experimental Setup

We evaluate Remap using the Sora software radio platform [6]. Sora has a full-fledged 802.11 g physical layer according to the standard. The OFDM implementation uses the 802.11 g standard preamble structure. We have implemented both Remap decoding of non-matching collisions and matching collisions. However, we focus on evaluating Remap decoding of the non-matching collision case. Remap works well with a variety of modulation schemes. In this evaluation, we use Binary Phase Shift Keying (BPSK). BPSK is used for the 6 Mbps data rate of 802.11 g.

We perform the following experiments. We set up one SDR receiver, and two SDR senders A and B. We set sender A to transmit on channel 3. We fix the receiver at channel 3 as well. We change the locations of these nodes to get different SNRs. We perform two experiments for each location. In the first experiment, we set sender B to transmit at channel 4; in the second, we set B to transmit at channel 5. For each experiment, we let A and B send continuously for a duration. We call the data collected a dump. We perform 100 independent dumps. Each dump lasts several hundred micro-seconds which contains 10 to 20 independent packets. For each packet from A, we send the original version and 3 additional remap versions. B continuously sends random generated packets. After we collect the dump data, we post-process it. We first locate the preamble of each channel 3 packet and cut them into groups of 4 packets each. We adjust these 4 groups through the collision matching algorithm. We then decode each of the 4 packet samples. We collect BER and throughput. Since we know each packet A's content, we know whether each demodulated bit is correct or not. We then use the 802.11 g Viterbi decoder to decode the packet. If the packet passes through the CRC check, we then count the packet as decoded correctly. Otherwise, we count it as an error packet. Note that, we can decode at most two packets from each 4-packet group for collisions with channel 5, and at most one packet for collisions with channel 4. We normalize with the best throughput each setting can achieve.

We did our experiments at many locations in the floor of a big building. There are rarely any background 802.11b/g activities. We pick two representative locations to report. In both locations, we also perform decoding of normal collision-free transmissions of channel 3 packets. Almost all packets can be decoded. Furthermore, we decode the collision packets using a normal 802.11 decoder (the same decoding capability as a successive interference decoder). The throughput is virtually zero (a few packets out of about 1500 packets).

Non-Adjacent Channel Collision

TABLE 1
BER and normalized throughput at different locations

Scenario
Non-adjacent channel

| SNR (ch3, ch5) | BER | Throughput |
|---|---|---|
| (26.3 dB, 21.2 dB) | 3.3 × 10⁻³ | 0.81 |
| (22.3 dB, 13.5 dB) | 6.6 × 10⁻⁴ | 0.98 |

Table 1 shows the overall throughput of the two settings. Note that the SNR of 21.2 dB of channel 5 is the measured SNR at the receiver which is tuned to channel 3. We see that, with SNR difference about 5 dB and 9 dB between channel 3 and channel received signal strength, the normalized throughput is 0.81, 0.98 (i.e., 1 means all collisions are decoded correctly).

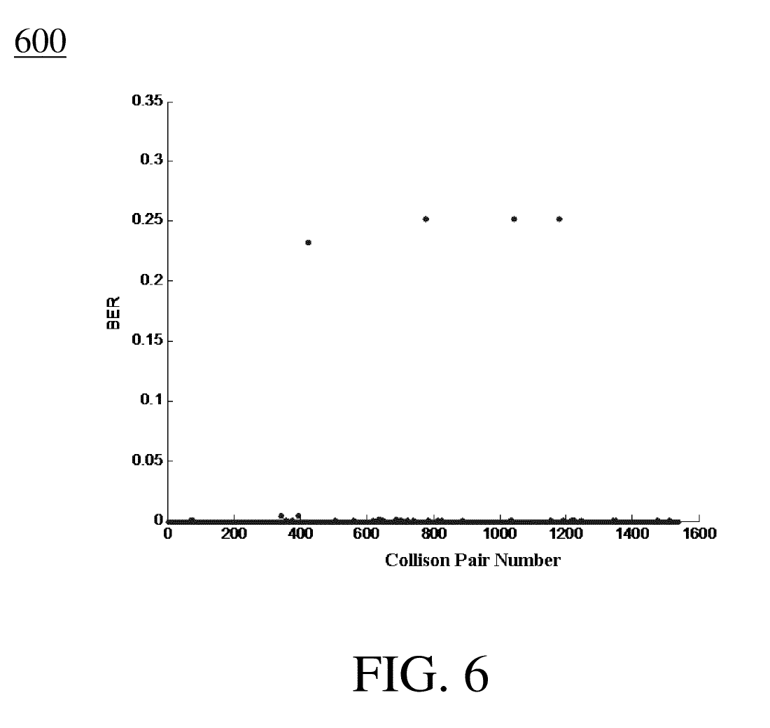

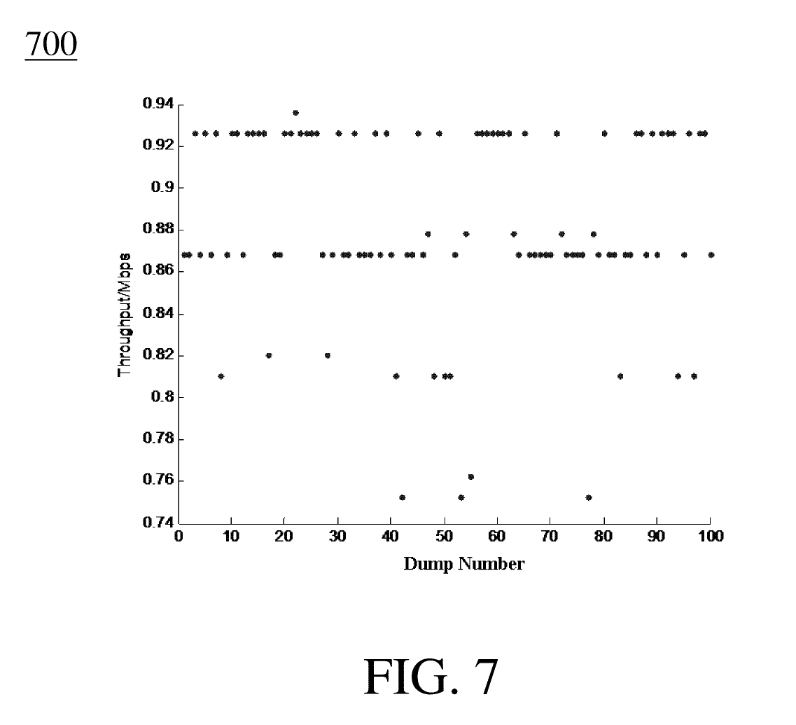

To have a detailed understanding of the BER of each collision group and the throughput of each dump, we plot the scatter plot of each. We only show the second experiment. As shown in graphs 600 and 700 of FIGS. 6 and 7, the BER of most collision pairs are very low. A few are very high around 25%. This is due to the fact that we missed the preamble of a channel 3 packet. So half of the subcarriers will be decoded incorrectly. With half randomly decoded correctly, this results in a BER of 25%. Since these are few, it shows that our preamble location (timing acquisition) algorithm performs very well in these SNR settings.

Adjacent Channel Collision

TABLE 2
BER and normalized throughput at different locations

Scenario
Adjacent channel

| SNR (ch3, ch5) | BER | Throughput |
|---|---|---|
| (26.3 dB, 23.4 dB) | 4.1 × 10⁻² | 0.50 |
| (22 dB, 12.0 dB) | 6.6 × 10⁻⁴ | 0.91 |

Now we look at the adjacent channel collision case. Table 2 shows the overall throughput of the two settings. Note that, in the second case when the SNR difference is 10 which is similar to the non-adjacent channel case, the decoding probability is 0.91 which is similar to the non-adjacent channel collision case (0.98). However, when the SNR difference is 3 dB, only half of the packets decoded pass CRC check. When the SNR difference is 3 dB, the largest BER are clustered in 0.25 and 0.125. These are due to the error of our group separation algorithm (when interference is high). The rest of the packets that did not pass CRC are mostly due to high interference. The energy leaked from channel 4 causes the signal to interference and noise ratio to be low.

### Related Work

Remap's key contribution is the bit-to-subcarrier remapping approach for resolving collisions in overlapping channels. It is different from prior work on interference cancellation and joint decoding [20, 14, 11]. These techniques operate on a single collision and decoding capability is limited by the channel capacity. Remap is related to analog network coding [13]. However, a receiver capable of analog network coding can decode a collision only if it knows one of the colliding packets.

Zigzag is designed in the context of no bit-to-subcarrier remapping. Remap builds on top of Zigzag. Remap works for non-overlapping channel collisions and is designed to take advantage of bit-to-subcarrier remapping. Unlike Zigzag, Remap does not rely on matching collisions. Even in the case of two matching collisions, Remap enables diversity combining from receptions at multiple APs as used in [16]. The reason is that Remap can decode both packets involved in the collisions as long as the number of overlapping subcarriers is no more than half of the total.

Remap differs from prior work on the MAC layer [12, 3] that avoids collisions. Remap decodes collisions and works with 802.11 MAC without any modifications.

The concept of decoding interfering users has been an area of intense study in communication and information theory. These techniques such as MIMO [19] and recent interference alignment [9, 8, 4] require synchronization, coding and scheduling. In contrast, Remap resolves collisions without these requirements.

### APPENDIX

802.11 Specifics of Remap

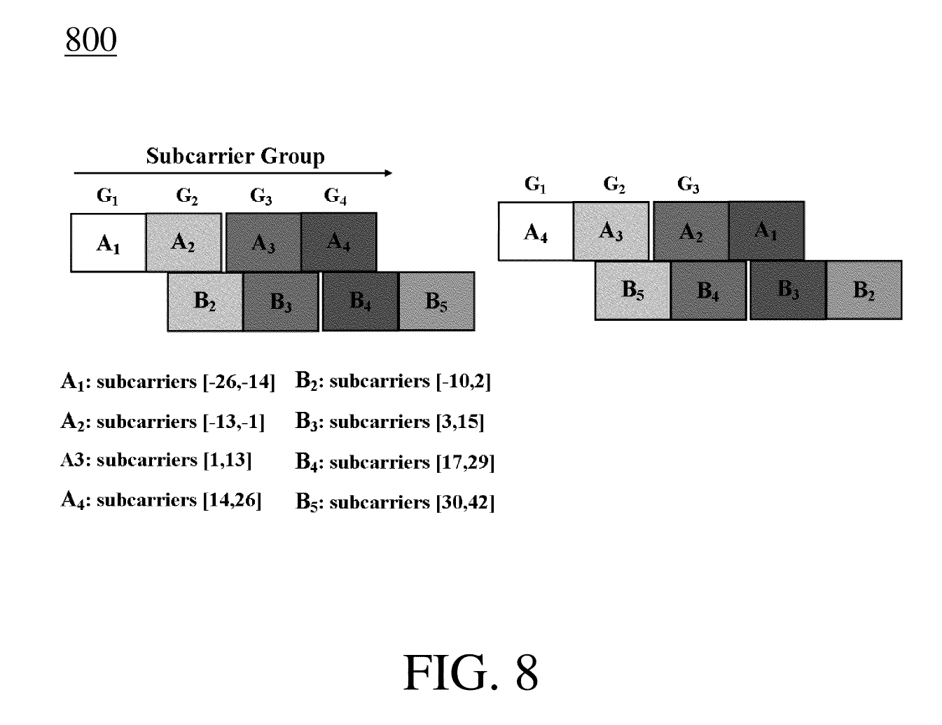

In this appendix, we discuss some 802.11 specifics of Remap decoding. 802.11 index subcarriers from −32 to +31. Subcarriers [−32,−27], [27,31] and 0 are unused. Subcarriers −21,−7, +21,+7 are used as pilots. Non-pilot subcarriers in [−26,−1] and [1,26] are mapped with information bits. We divide subcarriers into four groups (G₁, G₂, G₃, G₄) with equal number of subcarriers in each group: [−26,−14], [−13,−1], [1,13] and [14,26]. However, the adjacent channel subcarrier groups do not align with the prime channel. In particular, its subcarrier groups are mapped into [−10,2], [3,15], [17,29] and [30,42] as shown in diagram 800 of FIG. 8.
Bits A₁ (12 bits) maps to subcarrier group G₁: [−26,−14] (from subcarrier −26 to −14, 13 subcarriers, −21 is the pilot)
Bits A₂ (12 bits) maps to subcarrier group G₂: [−13,−1]
Bits A₃ (12 bits) maps to subcarrier group G₃: [1,13]
Bits A₄ (12 bits) maps to subcarrier group G₄: [14,26]
When remap A₁ from G₁ to G₄, subcarrier −26 maps to subcarrier 14, subcarrier −14 maps to 26, i.e. subcarrier j in G₁ maps to 40+j in G₄
When remap A₂ from G₂ to G₃, subcarrier −13 maps to subcarrier 1,
Subcarrier −1 maps to 13, i.e. subcarrier j in G₂ maps to 14+j in G₃
When remap A₃ from G₃ to G₂, subcarrier 1 maps to subcarrier −13, subcarrier 13 maps to −1, i.e. subcarrier j in G₃ maps to −14+j in G₂
When remap A₄ from G₄ to G₁ subcarrier 14 maps to subcarrier −26, subcarrier 26 maps to −14, i.e. subcarrier j in G₄ maps to −40+j in G₁

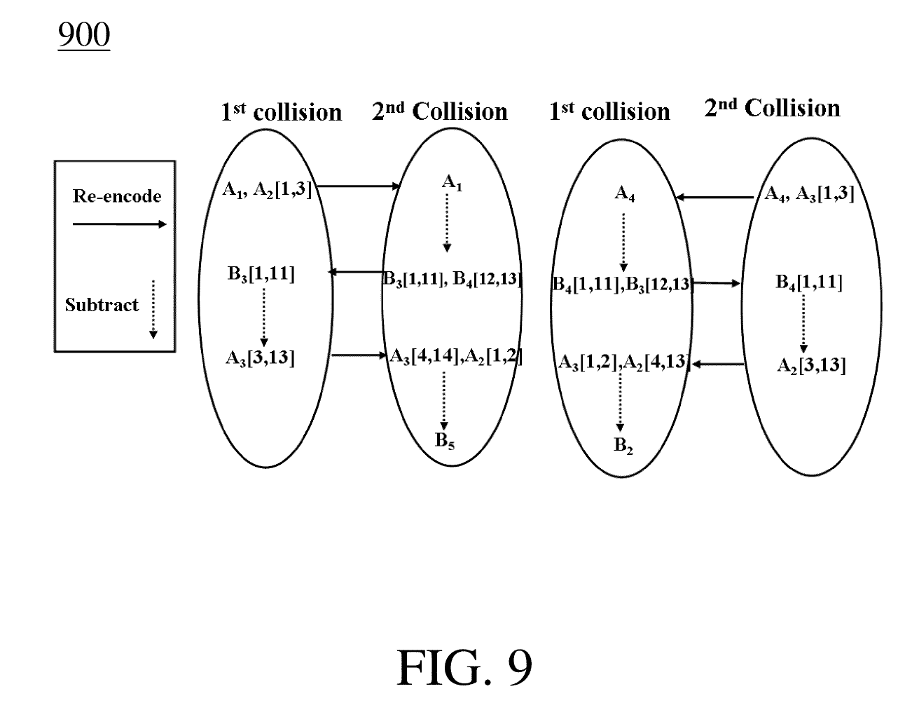

We modify the Remap decoding process as shown in diagram 900 of FIG. 9. Note that, we should try to avoid decoding the adjacent channel subcarriers if it falls into the unused subcarriers of the prime channel. In our decoding process, we only make use of one unused subcarrier, +27. Bᵢ[j,k] denotes the subcarrier indexed from j to k within the subcarrier groups Bᵢ uses. For example, B₃[1,11] refers to subcarriers [3,13] for the first collision. We need subcarrier +27 to decode B₃[11] and B₄[11]. Since it is adjacent to used subcarriers, the filter response should still be fine.

Overlapped Collisions

There are two cases. The first case is Pₐ is on the prime channel and the second case is P_{b} is on the prime channel. The main difference between decoding overlapped collisions from non-overlapped collisions is the dependency among different decoding paths. In the non-overlapped case, we can start decoding with either of the two collision-free bit sequences A₄ and A₁. This is not the case for overlapped collisions. Another difference is that we need to detect the start of the second collision in the overlapped case.

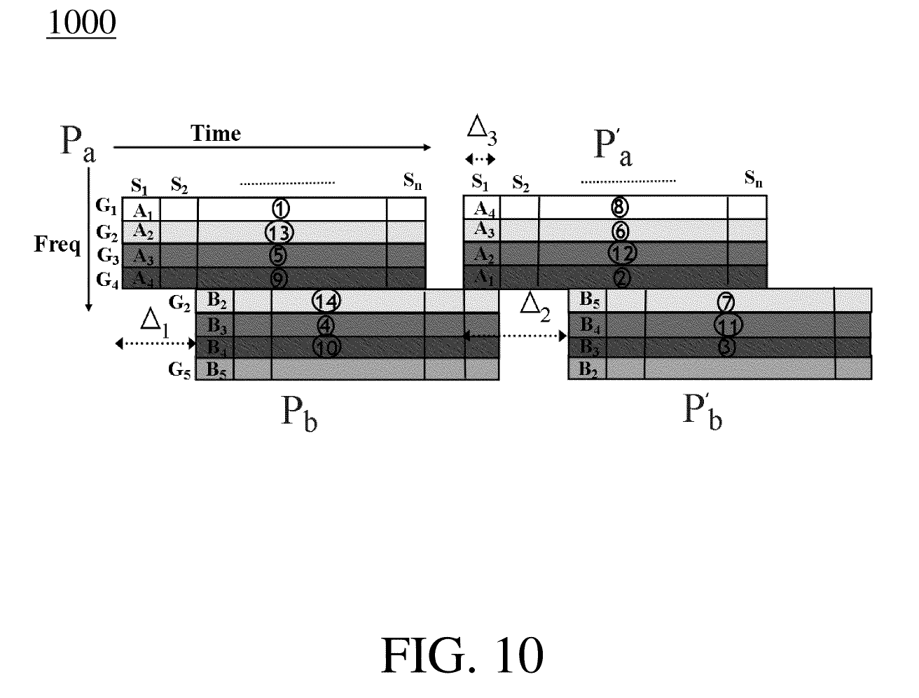

For the first case, we start with bit sequence A₁. The decoding and re-encoding, subtraction sequence is shown in diagram 1000 of FIG. 10. When we decode B₄ (on subcarrier group 4) at step 10, the samples at position interval Δ₃ of P_{b} is already subtracted of A₁ of P′ₐ (on the same subcarrier group 4). Thus, the decoding of B₄ hinges on the decoding path starting from A₁ finishing. If we start with A₄, then when we decode B₄, A₁ of P′ₐ would not have been subtracted out yet.

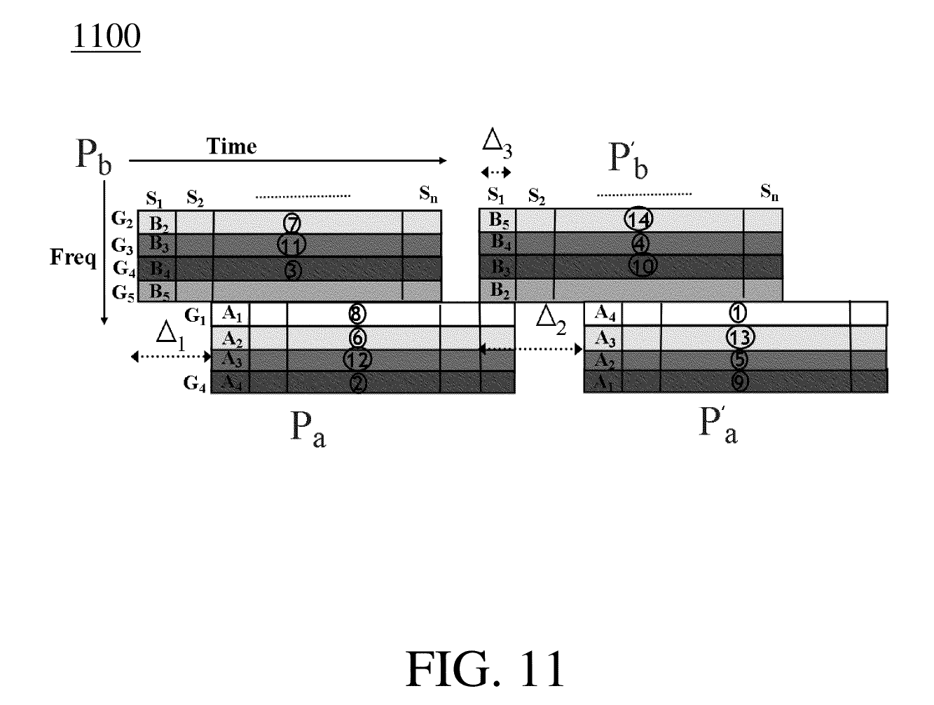

For the second case, we need to start with bit sequences A₄. The decoding and re-encoding, subtraction sequence is shown in diagram 1100 of FIG. 11.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

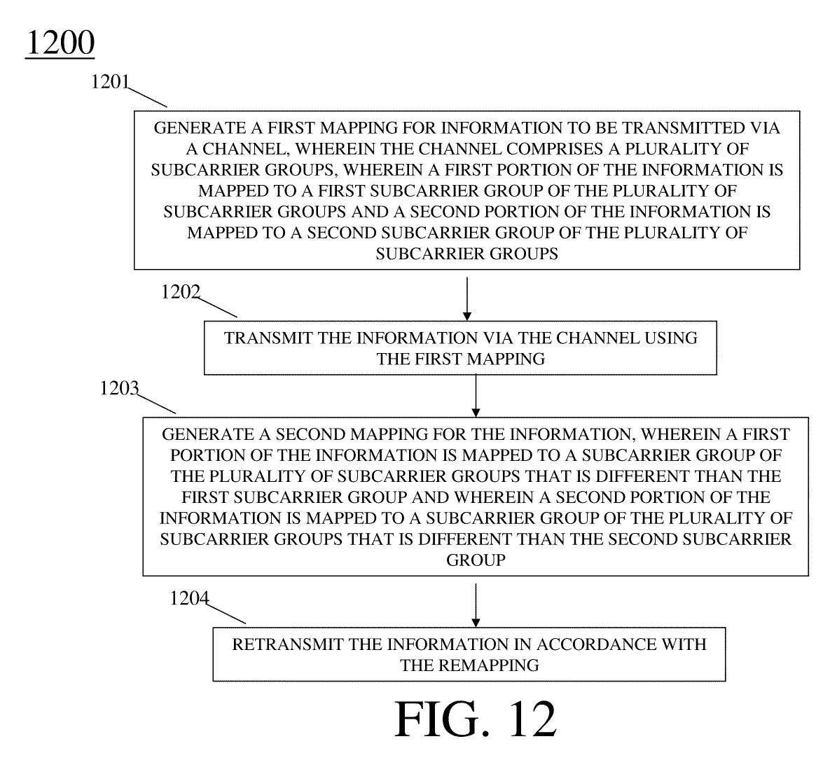

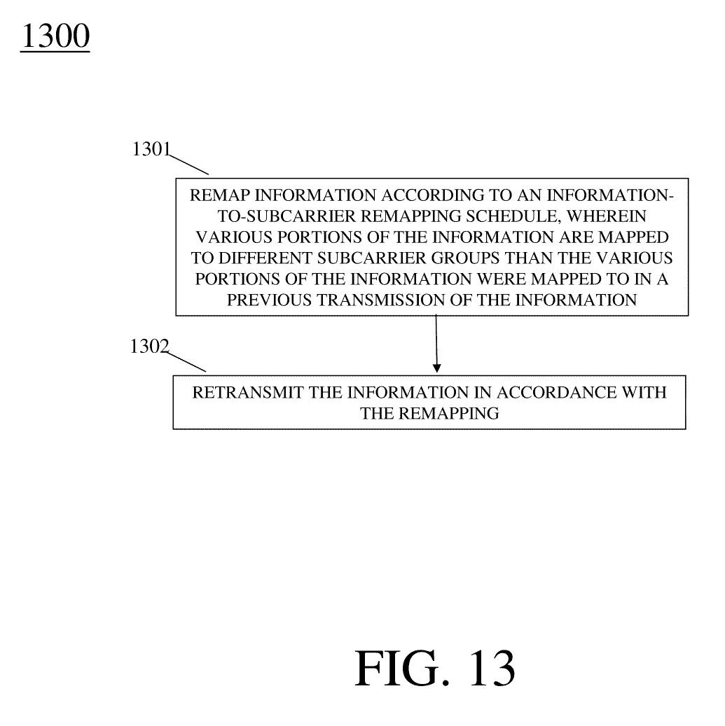

Aspects of embodiments of the present invention can be understood with reference to FIGS. 12-13. FIG. 12 is a logic flow diagram of retransmitting information in accordance with various embodiments of the present invention. In the method depicted in diagram 1200, a first mapping is generated (1201) for information to be transmitted via a channel. The channel includes a plurality of subcarrier groups, a first portion of the information is mapped to a first subcarrier group of this plurality of subcarrier groups and a second portion of the information is mapped to a second subcarrier group of the plurality of subcarrier groups. The information is transmitted (1202) via the channel using the first mapping. A second mapping is generated (1203) for the information. A first portion of the information is mapped to a subcarrier group of the plurality of subcarrier groups that is different than the first subcarrier group, while a second portion of the information is mapped to a subcarrier group of the plurality of subcarrier groups that is different than the second subcarrier group. The information is retransmitted (1204) via the channel using the second mapping. In this way, an information-to-subcarrier assignment is permuted during retransmission of the information.

FIG. 13 is also a logic flow diagram of retransmitting information in accordance with various embodiments of the present invention. In the method depicted in diagram 1300, information is remapped (1301) according to an information-to-subcarrier remapping schedule. Various portions of the information are mapped to different subcarrier groups than the various portions of the information were mapped to in a previous transmission of the information. The information is retransmitted (1302) in accordance with the remapping that is performed.

Below is a list of references that are referred to throughout the present specification:
[1] A. Akella, G. Judd, S. Seshan, and P. Steenkiste. Self-management in chaotic wireless deployments. In MobiCom '05: Proceedings of the 11th annual international conference on Mobile computing and networking, pages 185-199, New York, N.Y., USA, 2005. ACM.
[2] P. Bahl, R. Chandra, T. Moscibroda, R. Murty, and M. Welsh. White space networking with wi-fi like connectivity. In Proceedings of SIGCOMM, 2009.
[3] V. Bharghavan, A. Demers, S. Shenker, and L. Zhang. MACAW: A media access protocol for wireless LANs. In Proceedings of ACM SIGCOMM '94, pages 212-225, London, England, August 1994.
[4] V. R. Cadambe and S. A. Jafar. Interference alignment and the degrees of freedom for the k user interference channel. Preprint, 2007.
[5] R. Chandra, R. Mahajan, T. Moscibroda, R. Raghavendra, and P. Bahl. A case for adapting channel width in wireless networks. SIGCOMM Comput. Commun. Rev., 38(4):135-146, 2008.
[6] K. T. et al. Sora: High performance software radio using general purpose multi-core processors. In Proceedings of NSDI, 2009.
[7] S. Gollakota and D. Katabi. Zigzag decoding: combating hidden terminals in wireless networks. SIGCOMM Comput. Commun. Rev., 38(4), 2008.
[8] S. Gollakota, S. D. Perli, and D. Katabi. Overcoming the antennas-per-node throughput limit in mimo lans. Technical Report MIT-CSAIL-TR-2009-007, MIT, 2009.
[9] K. S. Gomadam, V. R. Cadambe, and S. A. Jafar. Approaching the capacity of wireless networks through distributed interference alignment. In Proceedings of IEEE GLOBECOM, 2008.
[10] R. Gummadi, R. Patra, H. Balakrishnan, and E. Brewer. Interference Avoidance and Control. In 7th ACM Workshop on Hot Topics in Networks (Hotnets-VII), Calgary, Canada, October 2008.
[11] D. Halperin, T. Anderson, and D. Wetherall. Taking the sting out of carrier sense: interference cancellation for wireless lans. In MobiCom '08: Proceedings of the 14th ACM international conference on Mobile computing and networking, pages 339-350, 2008.
[12] P. Karn. MACA—a new channel access method for packet radio. In ARRL/CRRL Amateur Radio 9th Computer Networking Conference, September 1990.
[13] S. Katti, S. Gollakota, and D. Katabi. Embracing wireless interference: Analog network coding. In Proceedings of ACM SIGCOMM, 2007.
[14] L. E. Li, R. Alimi, R. Ramjee, J. Shi, Y. Sun, H. Viswanathan, and Y. R. Yang. Superposition coding for wireless mesh networks. In MobiCom '07: Proceedings of the 13th annual ACM international conference on Mobile computing and networking, pages 330-333, 2007.
[15] A. Mishra, V. Shrivastava, S. Banerjee, and W. Arbaugh. Partially overlapped channels not considered harmful. SIGMETRICS Perform. Eval. Rev., 34(1):63-74, 2006.
[16] A. Miu, H. Balakrishnan, and C. E. Koksal. Improving loss resilience with multi-radio diversity in wireless networks. In MobiCom '05: Proceedings of the 11th annual international conference on Mobile computing and networking, pages 16-30, New York, N.Y., USA, 2005. ACM.
[17] M. Morelli, C. C. J. Kuo, and M. O. Pun. Synchronization techniques for orthogonal frequency division multiple access (ofdma): A tutorial review. Proceedings of the IEEE, 95(7):1394-1427, 2007.
[18] H. Samra and Z. Ding. Retransmission diversity schemes for multicarrier modulations. Wireless Communications, IEEE Transactions on, 5(5):1142-1147, 2006.
[19] D. Tse and P. Viswanath. Fundamentals of Wireless Communication. Cambridge University Press, May 2005.
[20] S. Verdu. Multiuser Detection. Cambridge University Press, New York, N.Y., 1998.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for retransmitting information, the method comprising:
generating a first mapping for information to be transmitted via a channel, wherein the channel comprises a plurality of subcarrier groups, wherein a first portion of the information is mapped to a first subcarrier group of the plurality of subcarrier groups and a second portion of the information is mapped to a second subcarrier group of the plurality of subcarrier groups;
transmitting the information via the channel using the first mapping;
generating a second mapping for the information, wherein a first portion of the information is mapped to a subcarrier group of the plurality of subcarrier groups that is different than the first subcarrier group and wherein a second portion of the information is mapped to a subcarrier group of the plurality of subcarrier groups that is different than the second subcarrier group;
retransmitting the information via the channel using the second mapping.

2. The method of claim 1, wherein generating the first mapping and generating the second mapping comprises generating a mapping according to a predefined information-to-subcarrier remapping schedule.

3. The method of claim 1, wherein each subcarrier group of the plurality of subcarrier groups comprises a plurality of subcarriers.

4. The method of claim 1, wherein the information comprises a packet.

5. The method of claim 1, wherein each portion of the information comprises at least one bit.

6. An article of manufacture comprising a processor-readable storage medium storing one or more software programs which when executed by one or more processors performs the steps of the method of claim 1.

7. A method for retransmitting information, the method comprising:
remapping information according to an information-to-subcarrier remapping schedule, wherein various portions of the information are mapped to different subcarrier groups than the various portions of the information were mapped to in a previous transmission of the information;
retransmitting the information in accordance with the remapping.

8. An article of manufacture comprising a processor-readable storage medium storing one or more software programs which when executed by one or more processors performs the steps of the method of claim 7.

9. A transceiver node of a communication system, the transceiver node being configured to communicate with other devices in the system, wherein the transceiver node is operative
to generate a first mapping for information to be transmitted via a channel, wherein the channel comprises a plurality of subcarrier groups, wherein a first portion of the information is mapped to a first subcarrier group of the plurality of subcarrier groups and a second portion of the information is mapped to a second subcarrier group of the plurality of subcarrier groups, to transmit the information via the channel using the first mapping, to generate a second mapping for the information, wherein a first portion of the information is mapped to a subcarrier group of the plurality of subcarrier groups that is different than the first subcarrier group and wherein a second portion of the information is mapped to a subcarrier group of the plurality of subcarrier groups that is different than the second subcarrier group, and
to retransmit the information via the channel using the second mapping.

10. A transceiver node of a communication system, the transceiver node being configured to communicate with other devices in the system, wherein the transceiver node is operative
to remap information according to an information-to-subcarrier remapping schedule, wherein various portions of the information are mapped to different subcarrier groups than the various portions of the information were mapped to in a previous transmission of the information, and
to retransmit the information in accordance with the remapping.
